(19) United States
(12) Patent Application Publication
(10) Pub. No.: US 2016/0268907 A1
(43) Pub. Date: Sep. 15, 2016

(54) Circuit and Method for Controlling Minimum On-Time of a Flyback Power Converter During Light Load Operation

(71) Applicant: RICHTEK TECHNOLOGY CORPORATION, Zhubei City (TW)

(72) Inventor: Yu-Chang CHEN, Nantou County (TW)

(21) Appl. No.: 15/060,203

(22) Filed: Mar. 3, 2016

(30) Foreign Application Priority Data
Mar. 9, 2015 (TW) 104107445

(51) Int. Cl. H02M 3/335

(52) U.S. Cl. CPC H02M 3/33507

(57) ABSTRACT

A control circuit of a flyback power converter utilizes at least one of the information of an input voltage and an output voltage of the flyback power converter for adaptively adjusting the minimum on-time of the flyback power converter, to prevent the flyback power converter during light load operation from generating an over output voltage or getting out of control if feedback control is failed.

### CROSS-REFERENCE TO RELATED APPLICATIONS

This application claims the priority benefit of Taiwan Patent Application No. 104107445, filed Mar. 9, 2015, the contents of which in its entirety are herein incorporated by reference.

### FIELD OF THE INVENTION

The present invention is related generally to a control circuit and method of a flyback power converter and, more particularly, to a circuit and method for adaptively adjusting the minimum on-time of a flyback power converter.

### BACKGROUND OF THE INVENTION

FIG. 1 shows a simplified circuitry of a conventional primary-side regulation (PSR) flyback power converter. The flyback power converter converts an alternating-current (AC) power source V_{AC} into a direct-current (DC) output voltage V_{OUT}. FIG. 2 is a waveform diagram of the flyback power converter shown in FIG. 1 during heavy load operation, in which the waveform 20 represents the voltage V_{WP}=V_{SW}−V_{IN} on a primary-side winding W_{P}, the waveform 22 represents a clamping current I_{CLAMP}, the waveform 24 represents a first voltage V_{AUX} on an auxiliary winding WA, the waveform 26 represent a second voltage V_{DET} on a pin DET of a control circuit 10, the waveform 28 represents the current I_{SW} that flows through the primary-side winding W_{P}, the waveform 30 represents the current I_{DO} on a secondary-side winding W_{S}, the waveform 32 represents the current I_{DAUX} that flows through a diode D_{AUX}, and the waveform 34 represents a switching signal V_{DRV}. Referring to FIGS. 1 and 2, a bridge rectifier 12 rectifies the AC power source V_{AC} to generate the input voltage V_{IN}. (A drain terminal of) A power switch Q1 is coupled to the primary-side winding W_{P} of a transformer TX1 in a serial connection. The control circuit 10 provides the switching signal V_{DRV} to switch the power switch Q1, so that the input voltage VIN can be converted into the output voltage V_{OUT}. Referring to waveforms 20, 22, 26, 28, and 34 in FIG. 2, when the switching signal V_{DRV} becomes a high level to turn on the power switch Q1, the voltage V_{SW} of the drain terminal of the power switch Q1 is almost 0. Thus, the voltage V_{WP} on the primary-side winding W_{P} of the transformer TX1 is similar to −V_{IN}. At this time, the current I_{SW} rises for storing energy. Moreover, in order to prevent the second voltage V_{DET} on the pin DET of the control circuit 10 from a negative voltage, an internal part of the control circuit 10 will provide the clamping current I_{CLAMP} to make the voltage V_{DET} to be held near a level of 0V. Referring to waveforms 20, 30, and 34 in FIG. 2, when the switching signal V_{DRV} becomes a low level to turn off the power switch Q1, the current I_{DO} will be generated on the secondary-side winding W_{S} to release the energy to a capacitor C_{O} via an output diode D_{O} to generate the output voltage V_{OUT}. Whereby, the power switch Q1 is switched periodically, and the electric energy can be converted into the output voltage V_{OUT} from the input voltage V_{IN}, so that the function of voltage conversion is achieved. Such PSR flyback power converter utilizes the transformer TX1 to detect the output voltage V_{OUT} when the power switch Q1 is turned off to achieve a feedback control of a constant output voltage. In the feedback control, at a “knee point” as shown by waveform 26 in FIG. 2, the pin DET of the control circuit 10 acquires a feedback voltage related to the output voltage V_{OUT}. At the “knee point”, A relationship between the first voltage V_{AUX} of the auxiliary winding W_{A} and the voltage V_{WS} of the secondary-side winding W_{S} is equal to a turn ratio. Namely, V_{AUX}=V_{WS}×(N_{A}/N_{S}). Wherein, N_{A} is the turn of the auxiliary winding W_{A}, and N_{S} is the turn of the secondary-side winding W_{S}. Accordingly, the first voltage V_{AUX} related to the output voltage V_{OUT} can be acquired via the auxiliary winding WA as shown by waveform 24 in FIG. 2. Thence, a voltage divider formed by resistors R1 and R2 divides the first voltage V_{AUX} to generate the second voltage V_{DET} to the pin DET of the control circuit 10. The control circuit 10 further samples-and-holds the second voltage V_{DET} at the “knee point” as the feedback voltage. At the “knee point”, the current I_{DO} of the secondary-side winding W_{S} is near 0 A as shown by time t3 of waveform 30 in FIG. 2 and a forward voltage V_{DO} of the output diode D_{O} is the lowest, so the accuracy of the feedback voltage can be enhanced. In the feedback control of the constant voltage, the control circuit 10 keeps detecting the output voltage V_{OUT} to adjust a peak current I_{SWPK} (as shown by waveform 28 in FIG. 2) of the power switch Q1 (and adjust a switching frequency of the power switch Q1) to hold the output voltage V_{OUT} quite near a setting value.

FIG. 3 is a waveform diagram of the flyback power converter shown in FIG. 1 during light load operation, in which the waveform 40 represents the voltage V_{WP}, the waveform 42 represent the clamping current I_{CLAMP}, the waveform 44 represents the first voltage V_{AUX}, the waveform 46 represents the second voltage V_{DET}, the waveform 48 represents the current I_{SW}, the waveform 50 represents the current I_{DO}, the waveform 52 represents the current I_{DAUX}, and the waveform 54 represents the switching signal V_{DRV}. During light load operation, the peak current I_{SWPK} or the on-time of the power switch Q1 is low or short, which easily resulted in a detection error on the feedback voltage. As a result, the feedback control of the output voltage will be failed, and the output voltage will be too high or out of control. Reasons might be as follows:
(1) Before the secondary-side winding of the transformer TX1 generates the current I_{DO} that flows through the output diode D_{O}, the current I_{SW} of the primary-side winding has to charge a parasitic capacitor C_{PSW} of the power switch Q1 and a capacitor C_{SN} of a buffer 14 to increase the voltages V_{SW} and V_{WS} to turn on the diode D_{O}.
(2) When the control circuit 10 is operated, a capacitor C_{VDD} has to provide a current I_{DD}, so a voltage of the capacitor C_{VDD} decreases. Thus, before the output diode D_{O} is turned on, the diode D_{AUX} will be turned on to generate the current I_{DAUX} for charging the capacitor C_{VDD}, as shown by waveform 32 in FIG. 2 and waveform 52 in FIG. 3. Aforementioned circumstance is more obvious during light load operation than that during heavy load operation.
(3) There is a parasitic capacitor C_{PDET} between the pin DET and a ground. The parasitic capacitor C_{PDET} includes the parasitic capacitor in the control circuit 10 and the parasitic capacitor on a printed circuit board (PCB). The parasitic capacitor C_{PDET} and the resistors R1 and R2 form an RC filter, which causes the waveform of the second voltage V_{DET} to be distorted and lag behind the first voltage V_{AUX}, as shown by waveforms 44 and 46 in FIG. 3.

As described above, during light load operation, the parasitic capacitor C_{PSW}, the capacitor C_{SN}, and the capacitor C_{VDD} need to be charged. Therefore, a peak current I_{DOPK} of the output diode D_{O} will be slightly lower than an ideal value n_{PS}×I_{SWPK}. Wherein, n_{PS}=N_{P}/N_{S}, and N_{S} is a turn of the primary-side winding W_{P}. Consequently, the conduction time of the diode D_{O} is shorter. Moreover, an RC delay effect on the pin DET also makes the second voltage V_{DET} at the “knee point” to be lower than a correspondent value of the practical output voltage V_{OUT}, which will result in the output voltage V_{OUT} too high or out of control. Thus, in order to detect the feedback voltage correctly and satisfy the need of input power during light load operation, keeping a minimum conduction time t_{ON}_{_}_{DO}_{_}_{MIN} of the output diode that can detect the output voltage V_{OUT} is a necessary design. In other words, setting a minimum of the conduction time of the power switch Q1 (i.e. a minimum of the on-time t_{ON} of the switching signal V_{DRV}) can keep a proper minimum conduction time t_{ON}_{_}_{DO}_{_}_{MIN} of the output diode. The existing method for controlling the minimum conduction time t_{ON}_{_}_{DO}_{_}_{MIN} of the output diode is limiting a minimum of the peak of the current I_{SW} on the primary-side winding L_{P} of the transformer TX1.

FIG. 4 shows a conventional control circuit 10 for controlling a minimum conduction time t_{ON}_{_}_{DO}_{_}_{MIN} of an output diode in the PSR flyback power converter. A switch circuit 60 in the control circuit 10 provides the switching signal V_{DRV} to control the power switch Q1. In the switch circuit 60, a driver 66 generates the switching signal V_{DRV} according to a pulse width modulation signal PWM on an output terminal Q of an SR flip-flop 64. When an oscillator 62 provides a clock CLK to a setting terminal S of the SR flip-flop 64, the pulse width modulation signal PWM will be triggered as shown by the time t1 of the waveform 34 in FIG. 2. Consequently, the switching signal V_{DRV} is converted into the high level for turning on the power switch Q1. When a resetting terminal of the SR flip-flop 64 receives a resetting signal S_{RESET}, the SR flip-flop 64 ends the pulse width modulation signal PWM as shown by the time t2 of the waveform 34 in FIG. 2. Consequently, the switching signal V_{DRV} is converted into the low level to turn off the power switch Q1. The control circuit in FIG. 4 further includes a feedback voltage sample-and-hold circuit 74 for receiving the second voltage V_{DET}. As shown by waveforms 26 and 30 in FIG. 2, when the power switch Q1 is turned off and the current I_{DO} decreases to zero or almost zero, the feedback voltage sample-and-hold circuit 74 will sample-and-hold the second voltage V_{DET} to generate a feedback voltage V_{SH}_{_}_{DET} related to the output voltage V_{OUT}. An error amplifier and feedback compensation network 76 amplifies a difference between the feedback voltage V_{SH}_{_}_{DET} and a reference voltage V_{REF} to generate a current threshold V_{TH}_{_}_{CS}. A minimum voltage clamping circuit 78 is utilized to limit a minimum V_{TH}_{_}_{CS}_{_}_{MIN} of the current threshold V_{TH}_{_}_{CS}. Namely, the minimum of the peak of the current I_{SW} on the primary-side winding W_{P} is limited. A current peak comparator 72 compares the current threshold V_{TH}_{_}_{CS} with a sensing signal V_{CS} related to the current I_{SW} that flows through the primary-side winding W_{P}. When the sensing signal V_{CS} is higher than the current threshold V_{TH}_{_}_{CS}, the current peak comparator 72 sends a comparison signal OC for ending the on-time t_{ON} of the switching signal V_{DRV}. In order to prevent the pulse width modulation signal PWM from being reset incorrectly in view of an initial voltage spike of the sensing signal V_{CS} at the moment that the power switch Q1 is changing from off to on, a leading edge blanking unit 68 will generate a leading edge blanking signal LEB at the moment that the power switch Q1 is changing from off to on. An AND gate 70 will mask the comparison signal OC by the leading edge blanking signal LEB for a while, thereby generating the resetting signal S_{RESET}.

From the controlling method as shown in FIG. 4, the minimum conduction time

$${t}_{ON\_DOMIN} \approx \frac{{L}_{P}}{{n}_{PS} \cdot ( {V}_{OUT} + {V}_{DO} )} \cdot \frac{{V}_{TH\_CS \_MIN}}{{R}_{CS}}$$

of the output diode D_{O} can be deduced. Wherein, L_{P} represents an equivalent magnetizing inductance at two terminals of the primary-side winding W_{P}. From the equation, the following questions might be discovered:
(1) Power converters with different output watts usually need different sensing resistors R_{CS} serially connected to the power switch Q1. However, the minimum V_{TH}_{_}_{CS}_{_}_{MIN} of the current threshold V_{TH}_{_}_{CS} is fixed, so the minimum conduction time t_{ON}_{_}_{DO}_{_}_{MIN} of the output diodes D_{O} will be different.
(2) In the same power converter, when the output voltage V_{OUT} changes, the minimum conduction time t_{ON}_{_}_{DO}_{_}_{MIN} will also change; it will not be a fixed value.
(3) The minimum conduction time t_{ON}_{_}_{DO}_{_}_{MIN} of the output diode D_{O} is related to the selected equivalent magnetizing inductance L_{P} at the two terminals of the primary-side winding W_{P}. The minimum conduction time t_{ON}_{_}_{DO}_{_}_{MIN} of the output diode D_{O} is also related to a variation of the equivalent magnetizing inductance L_{P} when the power converter is operating or a distribution of the equivalent magnetizing inductance L_{P} in the time of mass production.
   Accordingly, in order to cover the variation range of the equivalent magnetizing inductance L_{P}, the output voltage V_{OUT}, and the sensing resistors R_{CS}, the minimum V_{TH}_{_}_{CS}_{_}_{MIN} of the current threshold V_{TH}_{_}_{CS} should be higher enough, so that the output voltage V_{OUT} can be detected successfully during the minimum conduction time t_{ON}_{_}_{DO}_{_}_{MIN} of the output diode D_{O}. However, such design might result in the control circuit 10 unfit difficult to adapt to different systems and cause the defects such as the input power during no load operation increasing, the lower loadless switching frequency, or the poorer dynamic load response.

### SUMMARY OF THE INVENTION

An objective of the present invention is to provide a control circuit of a flyback power converter for preferably adjusting a minimum on-time of the power switch and a control method thereof.

Another objective of the present invention is to provide a control circuit and a control method for adaptively adjusting the minimum on-time of the power switch according to at least one of the input voltage and the output voltage.

According to the present invention, a control circuit of a flyback power converter comprises a switch circuit and a detection circuit. The switch circuit generates a switching signal for controlling the switching of a power switch to make the flyback power converter to convert an input voltage into an output voltage. The detection circuit adjusts a minimum of an on-time of the switching signal according to a second voltage that is in a proportional relationship to a first voltage on an auxiliary winding of a transformer. The detection circuit includes a feedback voltage sample-and-hold circuit configured to operably sample-and-hold the second voltage to generate a feedback voltage related to the output voltage when the power switch is turned off and a current of a secondary-side winding of the transformer decreases to zero or almost zero. The detection circuit further includes a minimum on-time generator configured to operably provide a pulse signal and generate a clamping current related to the input voltage to hold the second voltage at a zero voltage, a voltage closed to zero or a certain constant voltage when the power switch is turned on, wherein a pulse width of the pulse signal is determined by the feedback voltage and the clamping current and the pulse width of the pulse signal decides the minimum. The detection circuit further includes an error amplifier and feedback compensating circuit configured to operably amplify a difference between the feedback voltage and a reference voltage to generate a current threshold. The detection circuit further includes a current peak comparator configured to operably compare the current threshold with a sensing signal related to a current that flows through the primary-side winding to generate a comparison signal to end the on-time of the switching signal when the sensing signal is higher than the current threshold. The detection circuit further includes a signal mask logic circuit configured to operably mask the comparison signal according to the pulse signal to make the on-time of the switching signal to be not lower than the minimum.

According to the present invention, a control circuit of a flyback power converter comprises a switch circuit and a detection circuit. The switch circuit generates a switching signal for controlling the switching of a power switch to make the flyback power converter to convert an input voltage into an output voltage. The detection circuit adjusts a minimum of an on-time of the switching signal according to a second voltage that is in a proportional relationship to a first voltage on an auxiliary winding of a transformer. The detection circuit includes a feedback voltage sample-and-hold circuit configured to operably sample-and-hold the second voltage to generate a feedback voltage related to the output voltage when the power switch is turned off and the current on the secondary-side winding of the transformer decreases to zero or almost zero. The detection circuit further includes a minimum on-time generator configured to operably provide a pulse signal and determine a pulse width of the pulse signal according to the feedback voltage, wherein the pulse width of the pulse signal decides the minimum. The detection circuit further includes an error amplifier and feedback compensating circuit configured to operably amplify a difference between the feedback voltage and a reference voltage to generate a current threshold. The detection circuit further includes a current peak comparator configured to operably compare the current threshold with a sensing signal related to a current that flows through the primary-side winding of the transformer to generate a comparison signal to end the on-time of the switching signal when the sensing signal is higher than the current threshold. The detection circuit further includes a signal mask logic circuit coupled to the minimum on-time generator and the current peak comparator, configured to operably mask the comparison signal according to the pulse signal to make the on-time of the switching signal to be not lower than the minimum.

According to the present invention, a control circuit of a flyback power converter comprises a switch circuit and a detection circuit. The switch circuit generates a switching signal for controlling the switching of a power switch to make the flyback power converter to convert an input voltage into an output voltage. The detection circuit adjusts a minimum of an on-time of the switching signal according to a second voltage that is in a proportional relationship to a first voltage on an auxiliary winding of a transformer. The detection circuit includes a minimum on-time generator configured to operably provide a pulse signal and generate a clamping current related to the input voltage when the power switch is turned on to hold the second voltage at a zero voltage, a voltage closed to zero or a certain constant voltage, wherein a pulse width of the pulse signal is determined by the clamping current and the pulse width of the pulse signal decides the minimum. The detection circuit further includes a feedback voltage sample-and-hold circuit configured to operably sample-and-hold the second voltage to generate a feedback voltage related to the output voltage when the power switch is turned off and the current on the secondary-side winding of the transformer decreases to zero or almost zero. The detection circuit further includes an error amplifier and feedback compensating circuit configured to operably amplify a difference between the feedback voltage and a reference voltage to generate a current threshold. The detection circuit further includes a current peak comparator configured to operably comparing the current threshold with a sensing signal related to a current that flows through the primary-side winding to generate a comparison signal to end the on-time of the switching signal when the sensing signal is higher than the current threshold. The detection circuit further includes a signal mask logic circuit configured to operably mask the comparison signal according to the pulse signal to make the on-time of the switching signal to be not lower than the minimum.

According to the present invention, a controlling method for a flyback power converter comprises the steps of: generating a switching signal for controlling a switching of a power switch to make the flyback power converter to convert an input voltage into an output voltage, wherein during an on-time of the switching signal, the power switch will be turned on, and during an off-time of the switching signal, the power switch will be turned off; and adjusting a minimum of the on-time of the switching signal according to a second voltage that is in a proportional relationship to a first voltage on an auxiliary winding of a transformer. The step of adjusting the minimum according to the second voltage includes the steps of: sampling-and-holding the second voltage to generate a feedback voltage related to the output voltage when the power switch is turned off and the current on the secondary-side winding of the transformer decreases to zero or almost zero; generating a clamping current related to the input voltage to hold the second voltage at a zero voltage, a voltage closed to zero or a certain constant voltage when the power switch is turned on; providing a pulse signal, wherein a pulse width of the pulse signal is determined by the feedback voltage and the clamping current and the pulse width of the pulse signal determines the minimum; amplifying a difference between the feedback voltage and a reference voltage to generate a current threshold; comparing the current threshold with a sensing signal related to a current that flows through the primary-side winding to generate a comparison signal to end the on-time of the switching signal when the sensing signal is higher than the current threshold; and masking the comparison signal by the pulse signal to make the on-time of the switching signal to be not lower than the minimum.

According to the present invention, a controlling method for a flyback power converter comprises the steps of: generating a switching signal for controlling a switching of a power switch to make the flyback power converter to convert an input voltage into an output voltage, wherein during an on-time of the switching signal, the power switch will be turned on, and during an off-time of the switching signal, the power switch will be turned off; and adjusting a minimum of an on-time of the switching signal according to a second voltage that is in a proportional relationship to a first voltage on an auxiliary winding of a transformer. The step of adjusting the minimum according to the second voltage includes the steps of: sampling-and-holding the second voltage to generate a feedback voltage related to the output voltage when the power switch is turned off and the current on the secondary-side winding of the transformer decreases to zero or almost zero; providing a pulse signal, wherein a pulse width of the pulse signal is determined by the feedback voltage and the pulse width of the pulse signal determines the minimum; amplifying a difference between the feedback voltage and a reference voltage to generate a current threshold; comparing the current threshold with a sensing signal related to a current that flows through the primary-side winding of the transformer to generate a comparison signal to end the on-time of the switching signal when the sensing signal is higher than the current threshold; and masking the comparison signal by the pulse signal to make the on-time of the switching signal to be not lower than the minimum.

According to the present invention, a controlling method for a flyback power converter comprises the steps of: generating a switching signal for controlling a switching of a power switch to make the flyback power converter to convert an input voltage into an output voltage, wherein during an on-time of the switching signal, the power switch will be turned on, and during an off-time of the switching signal, the power switch will be turned off; and adjusting a minimum of an on-time of the switching signal according to a second voltage that is in a proportional relationship to a first voltage on an auxiliary winding of a transformer. The step of adjusting the minimum according to the second voltage includes the steps of: generating a clamping current related to the input voltage to hold the second voltage at a zero voltage, a voltage closed to zero or a certain constant voltage when the power switch is turned on; providing a pulse signal, wherein a pulse width of the pulse signal is determined by the clamping current and the pulse width of the pulse signal determines the minimum; sampling-and-holding the second voltage when the power switch is turned off and the current on the secondary-side winding of the transformer decreases to zero or almost zero to generate a feedback voltage related to the output voltage; amplifying a difference between the feedback voltage and a reference voltage to generate a current threshold; comparing the current threshold with a sensing signal related to a current that flows through the primary-side winding of the transformer to generating a comparison signal to end the on-time of the switching signal when the sensing signal is higher than the current threshold; and masking the comparison signal by the pulse signal to make the on-time of the switching signal to be not lower than the minimum.

### BRIE DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 shows a simplified circuitry of a primary-side regulation flyback power converter;

FIG. 2 is a waveform diagram of the flyback power converter shown in FIG. 1 during heavy load operation;

FIG. 3 is a waveform diagram of the flyback power converter shown in FIG. 1 during light load operation;

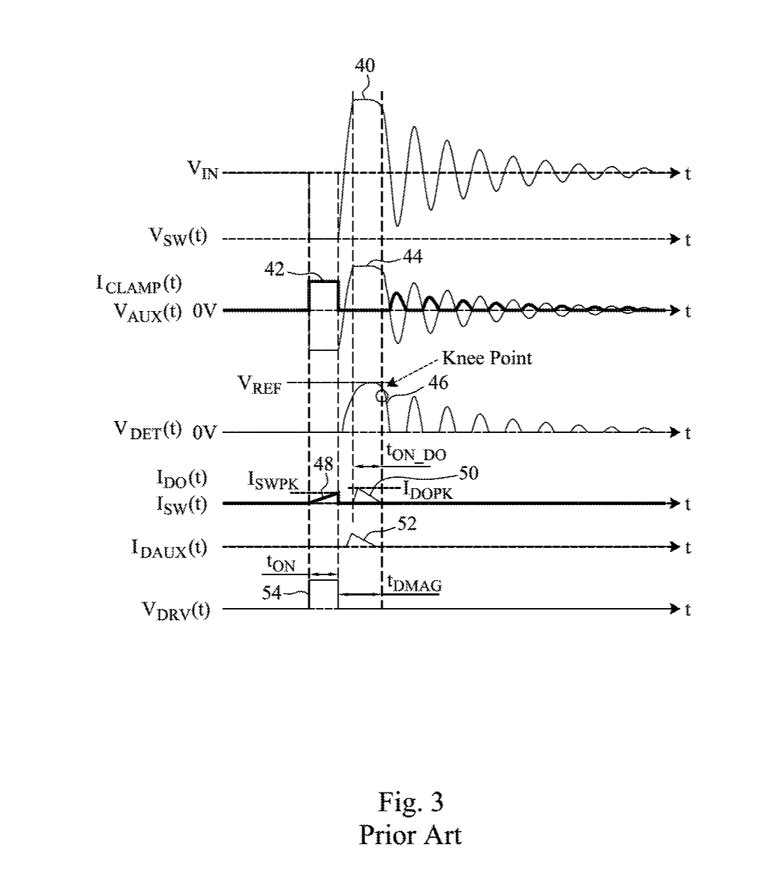

FIG. 4 is a conventional control circuit for controlling the minimum conduction time of the output diode of the flyback power converter shown in FIG. 1;

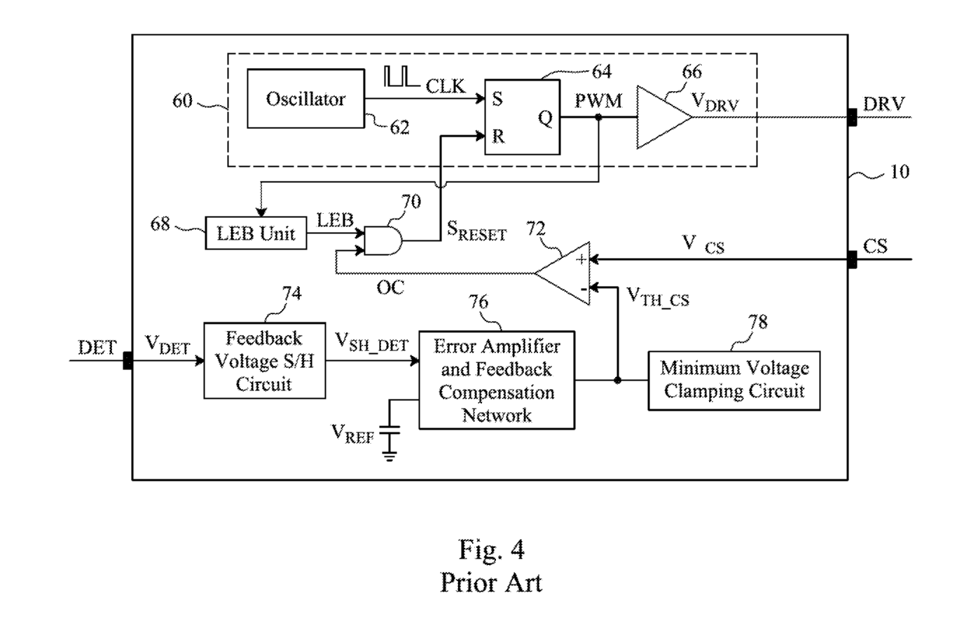

FIG. 5 shows a first embodiment of a control circuit according to the present invention;

FIG. 6 shows an embodiment of the minimum on-time generator shown in FIG. 5;

FIG. 7 shows another embodiment of the minimum on-time generator shown in FIG. 5;

FIG. 8 shows a second embodiment of a control circuit according to the present invention;

FIG. 9 shows an embodiment of the minimum on-time generator shown in FIG. 8;

FIG. 10 shows another embodiment of the minimum on-time generator shown in FIG. 8;

FIG. 11 shows a third embodiment of a control circuit according to the present invention; and

FIG. 12 shows an embodiment of the minimum on-time generator shown in FIG. 11.

### DETAILED DESCRIPTION OF THE INVENTION

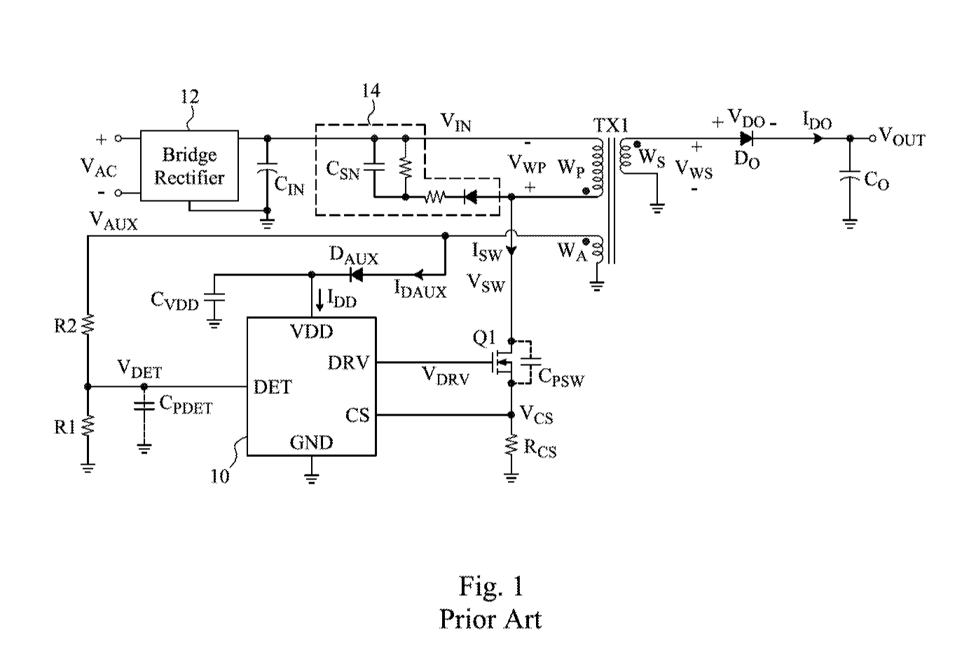

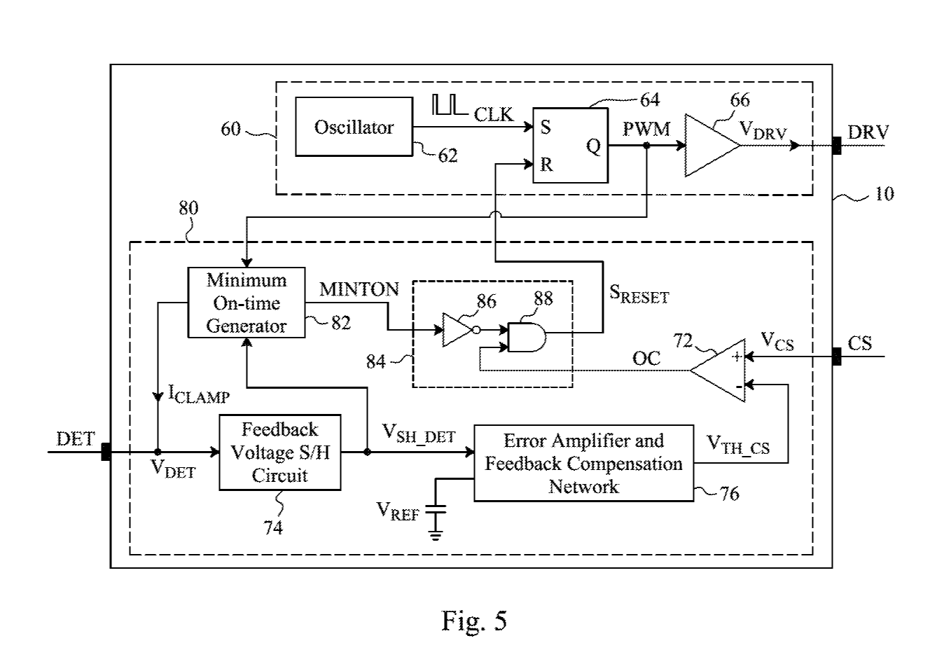

FIG. 5 shows a first embodiment of a control circuit 10 according to the present invention. In this embodiment, a switch circuit 60 provides a switching signal V_{DRV} to control the switching of a power switch Q1. A detection circuit 80 acquires information of an input voltage and information of an output voltage from a second voltage V_{DET} to adaptively adjust a minimum t_{ON}_{_}_{MIN} of an on-time t_{ON} of the switching signal V_{DRV}. Accordingly, the minimum t_{ON}_{_}_{MIN} will increase when the output voltage V_{OUT} increases, and decrease when the input voltage V_{IN} increases. Referring to FIGS. 1 and 5, an auxiliary winding W_{A} of a transformer TX1 generates a first voltage V_{AUX} in response to the switching of the power switch Q1. A voltage divider formed by resistors R1 and R2 divides the first voltage V_{AUX} to generate the second voltage V_{DET}. The switch circuit 60 includes an oscillator 62, an SR flip-flop 64 and a driver 66. The oscillator 62 provides a clock CLK to a setting terminal S of the SR flip-flop 64 for triggering a pulse width modulation signal PWM. When a resetting terminal R of the SR flip-flop 64 receives a resetting signal S_{RESET}, the SR flip-flop 64 will end the pulse width modulation signal PWM. The driver 66 generates the switching signal V_{DRV} according to the pulse width modulation signal PWM on an output terminal Q of the SR flip-flop 64.

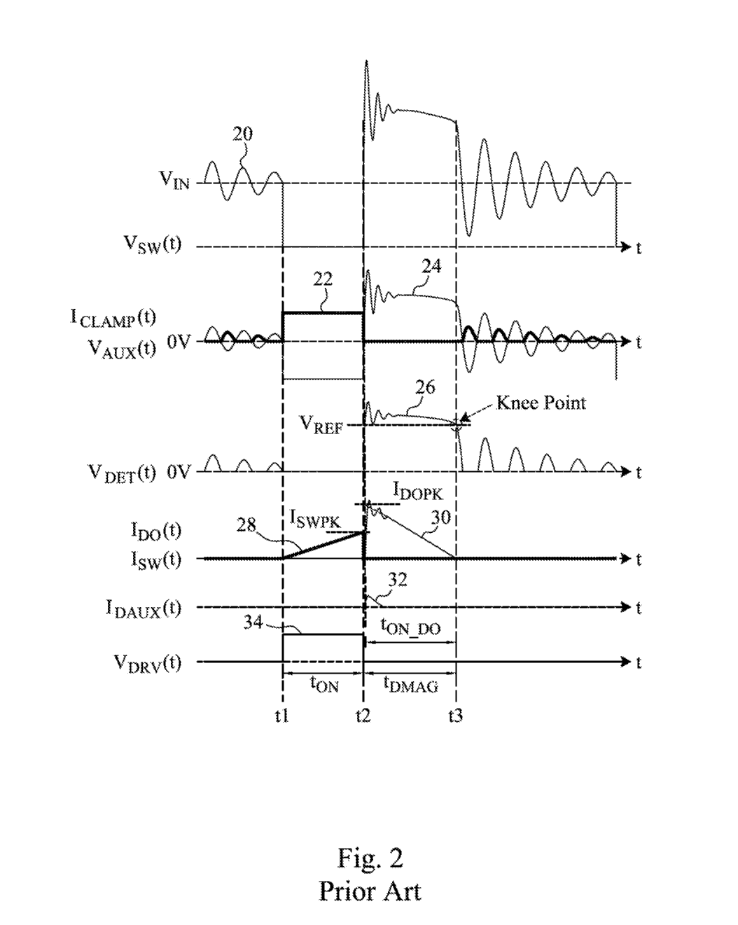

The detection circuit 80 in FIG. 5 includes a current peak comparator 72, a feedback voltage sample-and-hold circuit 74, an error amplifier and feedback compensating circuit 76, a minimum on-time generator 82, and a signal mask logic circuit 84. After the power switch Q1 is turned off over a preset time, the feedback voltage sample-and-hold circuit 74 samples-and-holds the second voltage V_{DET} to generate the feedback voltage V_{SH}_{_}_{DET} related to the output voltage V_{OUT}. Wherein, the preset time is lower than or equal to a conduction time t_{ON}_{_}_{DO} of a diode D_{O}. Preferably, when a current I_{DO} on a secondary-side winding W_{S} of the transformer TX1 decreases to zero or almost zero as shown by time t3 in FIG. 2, the second voltage V_{DET} will be sampled-and-held to generate the feedback voltage V_{SH}_{_}_{DET} related to the output voltage V_{OUT}. The error amplifier and feedback compensating circuit 76 amplifies a difference between the feedback voltage V_{SH}_{_}_{DET} and a reference V_{REF} to generate a current threshold V_{TH}_{_}_{CS} for determining a peak I_{SWPK} of a current I_{SW} on a primary-side winding W_{P} of the transformer TX1. The current peak comparator 72 compares the current threshold V_{TH}_{_}_{CS} with a sensing signal V_{CS} related to the current I_{SW}. When the sensing signal V_{CS} is higher than the current threshold V_{TH}_{_}_{CS}, the current peak comparator 72 will generate a comparison signal OC of a high level to end the on-time t_{ON} of the switching signal V_{DRV}. The minimum on-time generator 82 receives the feedback voltage V_{SH}_{_}_{DET} from the feedback voltage sample-and-hold circuit 74 and the pulse width modulation signal PWM from the switch circuit 60 and provides a pulse signal MINTON. When the power switch Q1 is turned on, the minimum on-time generator 82 generates a clamping current I_{CLAMP} related to the input voltage V_{IN} to make the second voltage V_{DET} to be held at a zero voltage, a voltage closed to zero or a certain constant voltage. Wherein a pulse width of the pulse signal MINTON is determined by the feedback voltage V_{SH}_{_}_{DET} and the clamping current I_{CLAMP}, and the pulse width of the pulse signal MINTON determines the minimum t_{ON}_{_}_{MIN} of the on-time of the switching signal V_{DRV}. The signal mask logic circuit 84 includes a flip-flop 86 and an AND gate 88. The signal mask logic circuit 84 masks the comparison signal OC according to the pulse signal MINTON to make the on-time t_{ON} of the switching signal V_{DRV} to be not lower than the minimum t_{ON}_{_}_{MIN}. In this embodiment, when the pulse width modulation signal PWM is converted into the high level, the pulse signal MINTON is also converted to the high level and held for a time t_{ON}_{_}_{MIN}. When the pulse signal MINTON is at the high level, the AND gate 88 will not send the resetting signal S_{RESET} even if the comparison signal OC becomes the high level. The AND gate 88 will not send the resetting signal S_{RESET} until the pulse signal MINTON is ended. Therefore, the on-time t_{ON} of the switching signal V_{DRV} has a minimum t_{ON}_{_}_{MIN}.

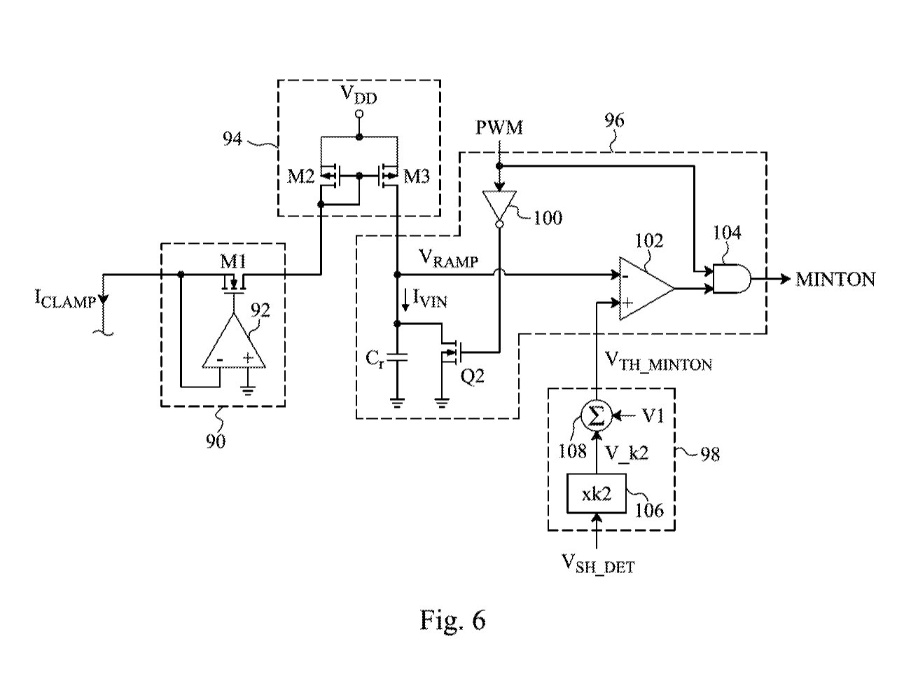

FIG. 6 shows an embodiment of the minimum on-time generator 82, which includes a minimum voltage clamping circuit 90, a current mirror 94, a pulse generator 96, and a threshold generator 98. When the power switch Q1 is turned on, the first voltage V_{AUX} on the auxiliary winding W_{A} is a negative voltage, as shown by waveform 24 in FIG. 2. When the minimum voltage clamping circuit 90 detects the second voltage V_{DET} that is slightly lower than 0V, an operation amplifier 92 in the minimum voltage clamping circuit 90 will control a transistor M1 to adaptively generate a clamping current I_{CLAMP} to hold the second voltage V_{DET} at the zero voltage. Wherein, the clamping current I_{CLAMP} equals to (n_{AP}×V_{IN})/R2, n_{AP} represents a turn ratio of primary-side winding W_{P} and the auxiliary winding WA. Herein, the turn ratio n_{AP} and the resistor R2 are both fixed values. Thus, the clamping current I_{CLAMP} is direct proportional to the input voltage V_{IN}. In other embodiments, the minimum voltage clamping circuit 90 can also hold the second voltage V_{DET} at a preset voltage that is not zero. The current mirror 94 mirrors the clamping current I_{CLAMP} to generate a mirror current I_{VIN}=k1×I_{CLAMP} which is direct proportional to the input voltage V_{IN}, wherein k1 is a constant. The threshold generator 98 includes an attenuator or amplifier 106 and an adder 108. The attenuator or amplifier receives the feedback voltage V_{SH}_{_}_{DET} and attenuates or amplifies the feedback voltage with a preset proportion k2 to generate a third voltage V_k2. If the preset proportion k2 is 1, the attenuator or amplifier 106 will be omitted. The adder 108 will add up the third voltage V_k2 and a reference voltage V1 to generate the minimum on-time threshold V_{TH}_{_}_{MINTON} related to the output voltage V_{OUT}. If the reference voltage V1 is 0, the adder 108 can be omitted. The pulse generator 96 includes a capacitor Cr coupled to the current mirror 94, a charge and discharge switch Q2 coupled to the capacitor Cr in a parallel connection, an inverter 100 for inverting the pulse width modulation signal PWM to generate a signal to control the charge and discharge switch Q2, a minimum on-time comparator 102, and an AND gate 104. Before the on-time of the switching signal V_{DRV} starts (or during the off-time), the pulse width modulation signal PWM is at the low level. Thus, the charge and discharge switch Q2 will be turned on to make the capacitor Cr to be discharged. At this time, a voltage V_{RAMP} of the capacitor Cr will be reset. During the on-time of the switching signal V_{DRV}, the pulse width modulation signal PWM is at the high level. Thus, the charge and discharge switch Q2 will be turned off, so that the mirror current I_{VIN} charges the capacitor Cr to increase the voltage V_{RAMP} of the capacitor Cr. At this time, the voltage V_{RAMP} of the capacitor Cr is lower than the minimum on-time threshold V_{TH}_{_}_{MINTON}, so the minimum on-time comparator 102 outputs a signal of the high level. Simultaneously, the pulse width modulation signal PWM is also at the high level, so the AND gate 104 will output the pulse signal MINTON of the high level to the signal mask logic circuit 84 to mask the comparison signal OC. When the voltage VAMP of the capacitor Cr equals to or higher than the minimum on-time threshold V_{TH}_{_}_{MINTON}, the output of the minimum on-time comparator 102 becomes the low level to end the pulse signal MINTON. At this time, the comparison signal OC will decide whether to trigger the resetting signal S_{RESET} for resetting the pulse width modulation signal PWM.

In FIGS. 5 and 6, the pulse width of the pulse signal MINTON determines the minimum t_{ON}_{_}_{MIN} of the on-time t_{ON} of the switching signal V_{DRV}, i.e. the minimum on-time of the power switch Q1. The pulse width (t_{ON}_{_}_{MIN}) of the pulse signal MINTON is determined by the mirror current I_{VIN} and the minimum on-time threshold V_{TH}_{_}_{MINTON}. Thus, the following equation can be obtained:

$${t}_{ON\_MIN} = \frac{Cr \cdot {V}_{TH\_MINTON}}{\frac{k 1 \cdot {n}_{AP} \cdot {V}_{IN}}{R 2}} = \frac{Cr}{k 1} \cdot \frac{( {V}_{OUT} + {V}_{DO} ) \cdot k 2 + V 1}{{V}_{IN}} \cdot {n}_{PS} \cdot R 2 \cdot \frac{R 1}{R 1 + R 2} , \qquad ( EQ \text{-} 1 )$$

which shows that the minimum t_{ON}_{_}_{MIN} of the on-time tot is modulated by the sum V_{OUT}+V_{DO}. Accordingly, the minimum t_{ON}_{_}_{MIN} will increase when the output voltage V_{OUT} increases. When the reference voltage V1 is 0V, the minimum t_{ON}_{_}_{MIN} is direct proportional to the sum V_{OUT}+V_{DO}. Obviously, when related parameters are set properly, the minimum conduction time t_{ON}_{_}_{DO}_{_}_{MIN} that is appropriate and almost constant or changing within a small range can be obtained. The equation is as follows:

$${t}_{ON\_MIN} = \frac{{n}_{PS} \cdot ( {V}_{OUT} + {V}_{DO} )}{{V}_{IN}} \cdot {t}_{ON\_DO \_MIN} ,$$

which shows that the minimum t_{ON}_{_}_{MIN} will increase when the value V_{OUT}+V_{DO} increases, and decreases when V_{IN} increases. Thus, if the system adjusts the minimum t_{ON}_{_}_{MIN} and the ratio

$$\frac{( {V}_{OUT} + {V}_{DO} )}{{V}_{IN}}$$

as being direct proportional to each other, then the minimum conduction time t_{ON}_{_}_{DO}_{_}_{MIN} of the output diode will be held in a constant value or changed within a small range. Accordingly, the minimum conduction time t_{ON}_{_}_{DO}_{_}_{MIN} of the diode D_{O} of the flyback power converter which is using the control circuit 10 of the present invention can be held at a constant value or changed within a small range when the output voltage V_{OUT} and the input voltage V_{IN} are changed. Thus, the feedback voltage V_{SH}_{_}_{DET} related to the output voltage V_{OUT} can be detected correctly. Moreover, when the output watt of the power converter is changed to make the sensing resistor R_{CS} to be changed, the minimum conduction time t_{ON}_{_}_{DO}_{_}_{MIN} of the output diode D_{O} can be held the same and does not need to redesign. Further, the minimum conduction time t_{ON}_{_}_{DO}_{_}_{MIN} of the output diode D_{O} is independent of an equivalent magnetizing inductance L_{P} at two terminals of the primary-side winding W_{P}. The minimum conduction time t_{ON}_{_}_{DO}_{_}_{MIN} of the output diode D_{O} is also independent of the variation of the equivalent magnetizing inductance L_{P} when the power converter is operating or the distribution of the equivalent magnetizing inductance L_{P} in the time of mass production.

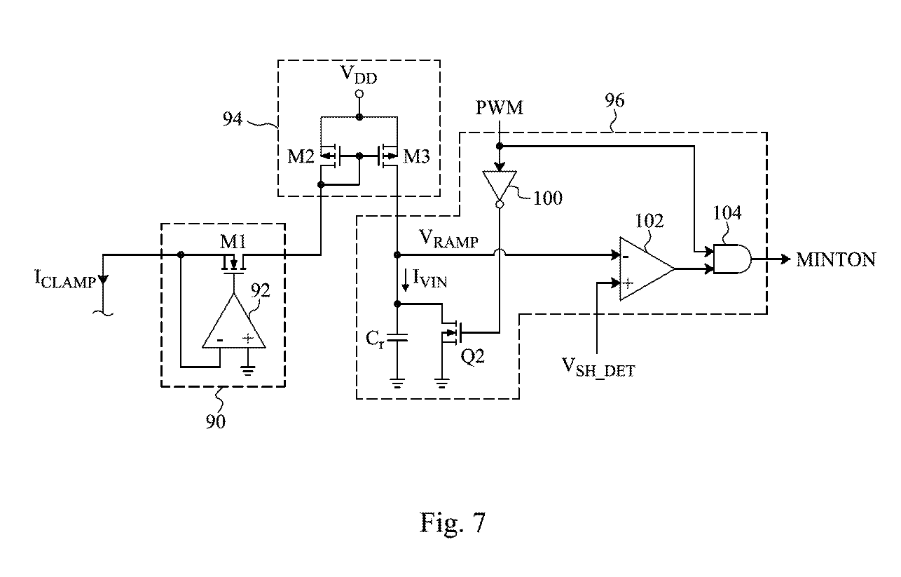

FIG. 7 shows another embodiment of the minimum on-time generator 82 in FIG. 7. This embodiment includes the same minimum voltage clamping circuit 90, current mirror 94, and pulse generator 96. Differently, the minimum on-time generator 82 in FIG. 7 omits the threshold generator 98. In this embodiment, the feedback voltage V_{SH}_{_}_{DET} is directly provided to the minimum on-time comparator 102 in the pulse generator 96. When the voltage V_{RAMP} of the capacitor Cr is lower than the feedback voltage V_{SH}_{_}_{DET}, the minimum on-time comparator 102 will output a signal of the high level.

The embodiments in FIGS. 5, 6, and 7 are applied to the situation that both the input voltage VIN and the output voltage V_{OUT} will change. In some applications, there is also a situation that the input voltage VIN or the output voltage V_{OUT} is a fixed value. Herein, the control circuit 10 of the present invention can be adjusted properly.

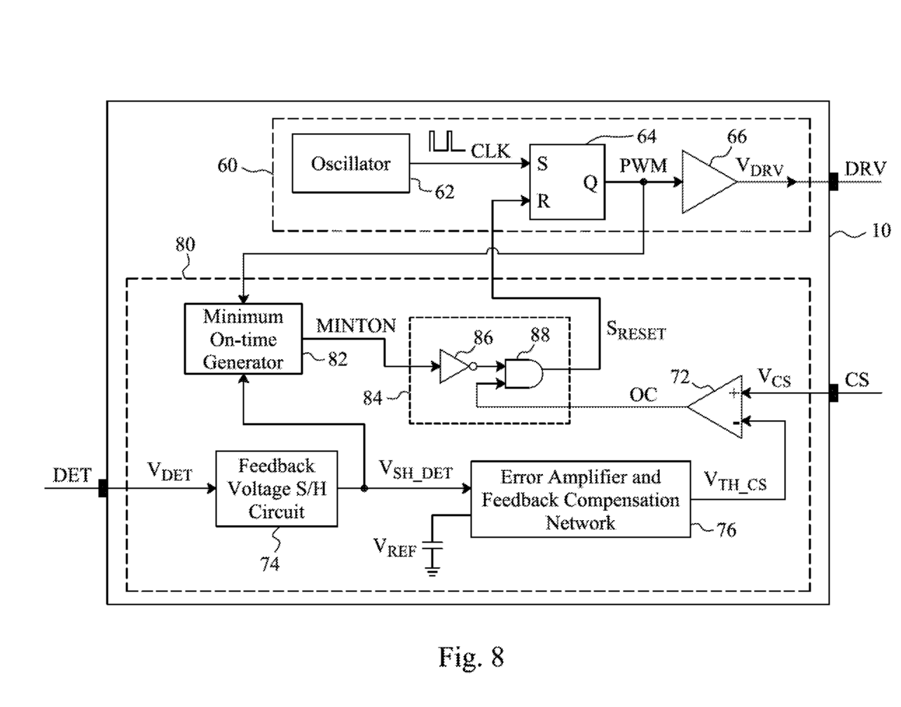

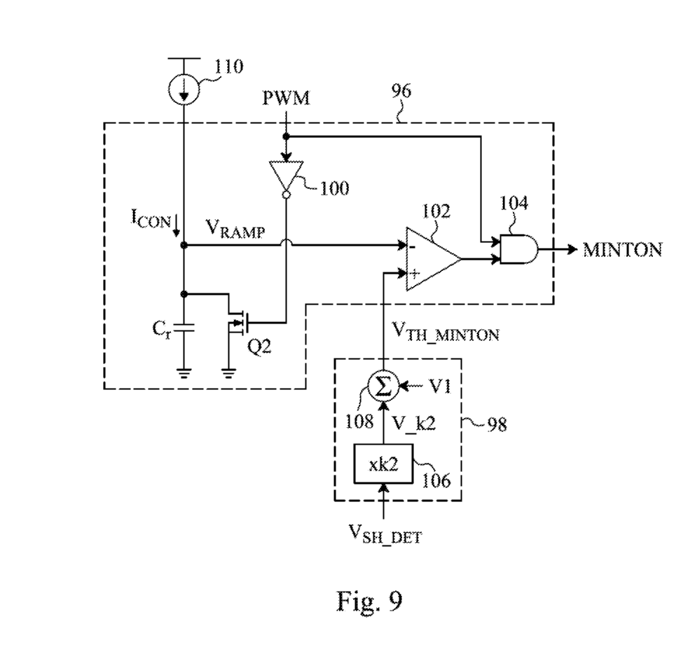

FIG. 8 shows a second embodiment of the control circuit 10 according to the present invention. This embodiment is applied to the situation that the input voltage V_{IN} is fixed. The control circuit 10 in FIG. 8 is the same as that in FIG. 5. The control circuit 10 in FIG. 8 includes the switch circuit 60 for providing a switching signal V_{DRV} to control the switching of the power switch Q1. However, the detection circuit 80 of the control circuit 10 in FIG. 8 merely acquires information of the output voltage from the second voltage V_{DET} to adaptively adjust the minimum t_{ON}_{_}_{MIN} of the on-time t_{ON} of the switching signal V_{DRV}. Thus, the minimum t_{ON}_{_}_{MIN} will increases when the output voltage V_{OUT} increases. The detection circuit 80 of FIG. 8 is the same as that of FIG. 5, which includes the current peak comparator 72, the feedback voltage sample-and-hold circuit 74, the error amplifier and feedback compensating circuit 76, the minimum on-time generator 82 and the signal mask logic circuit 84. The operation of the circuits in this embodiment are the same as those in the embodiment of FIG. 5 except for the minimum on-time generator 82 which determines the pulse width of the pulse signal MINTON according to the feedback voltage V_{SH}_{_}_{DET}. FIG. 9 shows an embodiment of the minimum on-time generator 82 in FIG. 8. The minimum on-time generator 82 in FIG. 9 includes a pulse generator 96, a threshold generator 98, and a constant current source 110. In FIG. 9, the operation of pulse generator 96 and the threshold generator 98 are the same as that in FIG. 6. However, the circuit in FIG. 9 utilizes the constant current source 110 to provide a constant current I_{CON} for charging the capacitor Cr. Namely, a rising speed of the voltage V_{RAMP} of the capacitor Cr is fixed. Therefore, the pulse width of the pulse signal MINTON is only controlled by the minimum on-time threshold V_{TH}_{_}_{MINTON}. In other words, the pulse width of the pulse signal MINTON is only related to the feedback voltage V_{SH}_{_}_{DET}. Referring to the equation EQ-2, the minimum t_{ON}_{_}_{MIN} of the on-time t_{ON} of the switching signal V_{DRV} will increase when the value V_{OUT}+V_{DO} increases, so the minimum conduction time t_{ON}_{_}_{DO}_{_}_{MIN} of the output diode can be held in a constant value or changed within a small range. Consequently, the feedback voltage V_{SH}_{_}_{DET} related to the output voltage V_{OUT} can be detected correctly. Moreover, when the output watt of the power converter is changing to make the sensing resistor R_{CS} to be changed, the minimum conduction time t_{ON}_{_}_{DO}_{_}_{MIN} of the output diode D_{O} can be held the same and does not need to redesign. Further, the minimum conduction time t_{ON}_{_}_{DO}_{_}_{MIN} of the output diode D_{O} is independent of an equivalent magnetizing inductance L_{P} at two terminals of the primary-side winding W_{P}. The minimum conduction time t_{ON}_{_}_{DO}_{_}_{MIN} of the output diode D_{O} is also independent of the variation of the equivalent magnetizing inductance L_{P} or the distribution of the equivalent magnetizing inductance L_{P} in the time of mass production.

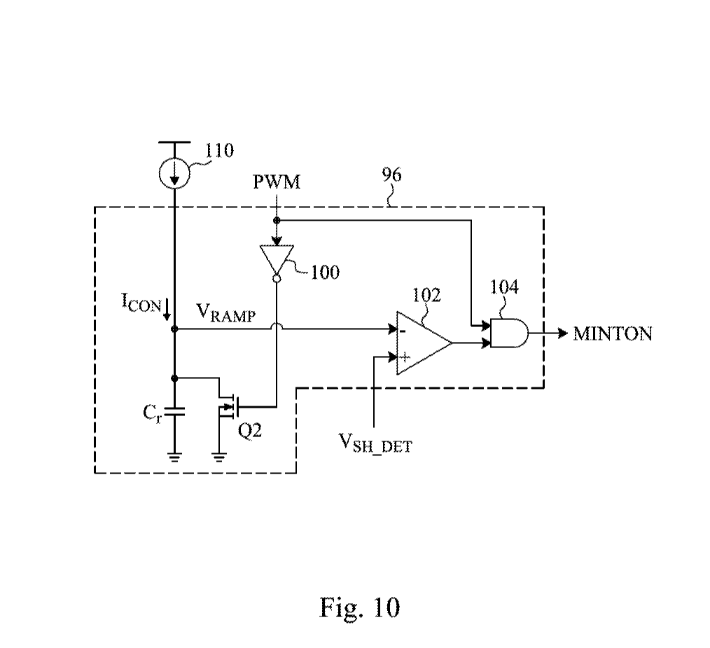

FIG. 10 shows another embodiment of the minimum on-time generator 82 in FIG. 8, which includes the pulse generator 96 and the constant current source 110. The minimum on-time generator 82 in FIG. 10 omits the threshold generator 98. In this embodiment, the feedback voltage V_{SH}_{_}_{DET} is directly provided to the minimum on-time comparator 102 in the pulse generator 96. When the voltage V_{RAMP} of the capacitor Cr is lower than the feedback voltage V_{SH}_{_}_{DET}, the minimum on-time comparator 102 will output a signal of the high level.

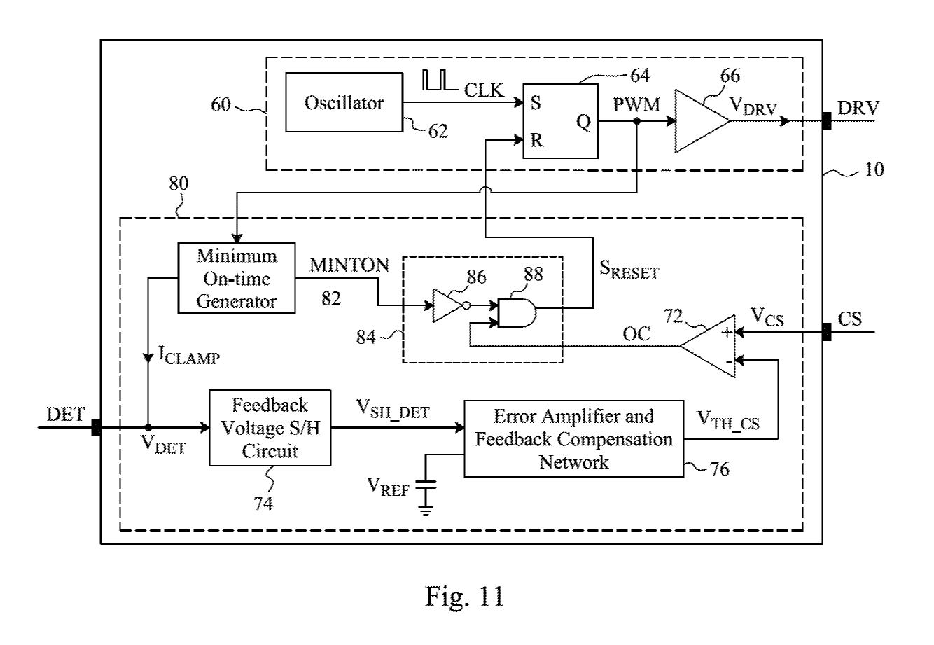

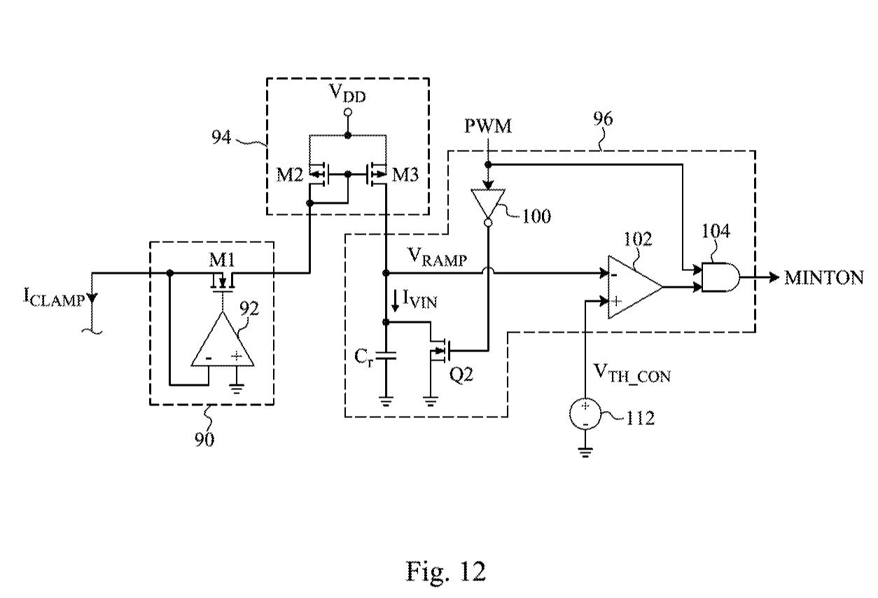

FIG. 11 shows a third embodiment of the control circuit 10 according to the present invention. This embodiment is applied to the situation that the output voltage V_{OUT} is fixed. The control circuit 10 depicted in FIG. 11 includes the same switch circuit 60 as that depicted in FIG. 6 for providing a switching signal V_{DRV} to control the switching of the power switch Q1. However, the detection circuit 80 of the control circuit 10 depicted in FIG. 11 adjusts the minimum t_{ON}_{_}_{MIN} of the on-time t_{ON} of the switching signal V_{DRV} according to the information of the input voltage V_{IN}. Accordingly, the minimum t_{ON}_{_}_{MIN} will decrease when the input voltage V_{IN} increases. The detection circuit 80 depicted in FIG. 11 includes the same circuitry as that depicted in FIG. 5. The detection circuit 80 depicted in FIG. 11 includes the current peak comparator 72, the feedback voltage sample-and-hold circuit 74, the error amplifier and feedback compensating circuit 76, the minimum on-time generator 82, and the signal mask logic circuit 84. The operation of the circuits in this embodiment are the same as those in FIG. 5 except for the minimum on-time generator 82 which does not receive the feedback voltage V_{SH}_{_}_{DET} to determine the pulse width of the pulse signal MINTON. FIG. 12 shows an embodiment of the minimum on-time generator 82 depicted in FIG. 11, which includes the minimum voltage clamping circuit 90, the current mirror 94, the pulse generator 96, and the constant voltage source 112. The operations of the minimum voltage clamping circuit 90, the current mirror 94, and the pulse generator 96 are the same as those depicted in FIG. 6. Differently, the embodiment shown in FIG. 12 utilizes the constant voltage source 112 to provide a fixed threshold V_{TH}_{_}_{CON} as the minimum on-time threshold. Thus, the pulse width of the pulse signal MINTON is only controlled by the mirror current I_{VIN}. Namely, the pulse width of the pulse signal MINTON is only related to the input voltage V_{IN}. Referring to the equation EQ-2, the minimum t_{ON}_{_}_{MIN} of the on-time t_{ON} of the switching signal V_{DRV} will decrease when V_{IN} increases, so the minimum conduction time t_{ON}_{_}_{DO}_{_}_{MIN} of the output diode can be held in a constant value or changed within a small range. Consequently, the feedback voltage V_{SH}_{_}_{DET} related to the output voltage V_{OUT} can be detected correctly. Moreover, when the output watt of the power converter is changing to make the sensing resistor R_{CS} to be changed, the minimum conduction time t_{ON}_{_}_{DO}_{_}_{MIN} of the output diode D_{O} can be held the same and does not need to redesign. Further, the minimum conduction time to t_{ON}_{_}_{DO}_{_}_{MIN} of the output diode D_{O} is independent of an equivalent magnetizing inductance L_{P} at two terminals of the primary-side winding W_{P}. The minimum conduction time t_{ON}_{_}_{DO}_{_}_{MIN} of the output diode D_{O} is also independent of the variation of the equivalent magnetizing inductance L_{P} or the distribution of the equivalent magnetizing inductance L_{P} in the time of mass production.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A control circuit of a flyback power converter which includes a transformer and a power switch, wherein the transformer has a primary-side winding coupled to the power switch, a secondary-side winding, and an auxiliary winding configured to operably generate a first voltage responsive to switching of the power switch, the control circuit comprising:
a switch circuit configured to operably generate a switching signal for controlling the switching of the power switch to make the flyback power converter to convert an input voltage into an output voltage, wherein the power switch will be turned on during an on-time of the switching signal and the power switch will be turned off during an off-time of the switching signal; and
a detection circuit coupled to the switch circuit and configured to operably adjust a minimum of the on-time of the switching signal according to a second voltage that is in a proportional relationship to the first voltage.

2. The control circuit of claim 1, further comprising a voltage divider formed by resistors and coupled to the auxiliary winding and the detection circuit, configured to operably divide the first voltage to generate the second voltage.

3. The control circuit of claim 1, wherein the detection circuit acquires an input voltage information from the second voltage during the on-time of the switching signal, acquires an output voltage information from the second voltage during the off-time of the switching signal and adjusts the minimum according to the input voltage information and the output voltage information.

4. The control circuit of claim 3, wherein the minimum increases as the output voltage increases, and decreases as the input voltage increases.

5. The control circuit of claim 1, wherein the detection circuit comprises:
a feedback voltage sample-and-hold circuit configured to operably sample-and-hold the second voltage to generate a feedback voltage related to the output voltage after the power switch is turned off over a preset time;
a minimum on-time generator coupled to the feedback voltage sample-and-hold circuit, configured to operably provide a pulse signal, and configured to operably generate a clamping current related to the input voltage when the power switch is turned on to hold the second voltage at a zero voltage or a preset voltage, wherein a pulse width of the pulse signal is determined by the feedback voltage and the clamping current and the pulse width of the pulse signal decides the minimum;
an error amplifier and feedback compensating circuit coupled to the feedback voltage sample-and-hold circuit and configured to operably amplify a difference between the feedback voltage and a reference voltage to generate a current threshold;
a current peak comparator coupled to the error amplifier and feedback compensating circuit, configured to operably compare the current threshold with a sensing signal related to a current that flows through the primary-side winding and configured to operably generate a comparison signal for ending the on-time of the switching signal when the sensing signal is higher than the current threshold; and
a signal mask logic circuit coupled to the minimum on-time generator and the current peak comparator and configured to operably mask the comparison signal according to the pulse signal to make the on-time of the switching signal to be not lower than the minimum.

6. The control circuit of claim 5, wherein the minimum on-time generator comprises:
a minimum voltage clamping circuit configured to operably generate the clamping circuit to hold the second voltage at a zero voltage or a preset voltage when the power switch is turned on;
a current mirror coupled to the minimum voltage clamping circuit and configured to operably mirror the clamping circuit to generate a mirror current;
a threshold generator configured to operably generate a minimum on-time threshold according to the feedback voltage; and
a pulse generator coupled to the current mirror and the threshold generator and configured to operably generating the pulse signal according to the mirror current and the minimum on-time threshold.

7. The control circuit of claim 6, wherein the threshold generator comprises:
an attenuator or an amplifier configured to operably attenuate or amplify the feedback voltage according to a preset proportion to generate a third voltage; and
an adder coupled to the attenuator or the amplifier and configured to operably add up the third voltage and a second reference voltage to generate the minimum on-time threshold.

8. The control circuit of claim 6, wherein the pulse generator comprises:
a capacitor coupled to the current mirror;
a charge and discharge switch coupled to the capacitor in a parallel connection, wherein the charge and discharge switch will be turned off to make the capacitor to be charged by the mirror current during the on-time of the switching signal and the charge and discharge switch will be turned on to reset a voltage of the capacitor before the on-time of the switching signal starts; and
a minimum on-time comparator coupled to the capacitor and the threshold generator and configured to operably compare the minimum on-time threshold with the voltage of the capacitor to generate the pulse signal.

9. The control circuit of claim 5, wherein the minimum on-time generator comprises:
a minimum voltage clamping circuit configured to operably generate the clamping current to hold the second voltage at a zero voltage or a preset voltage when the power switch is turned on;
a current mirror coupled to the minimum voltage clamping circuit and configured to operably mirror the clamping current to generate a mirror current; and
a pulse generator coupled to the current mirror and configured to operably generate the pulse signal according to the mirror current and the feedback voltage.

10. The control circuit of claim 9, wherein the pulse generator comprises:
a capacitor coupled to the current mirror;
a charge and discharge switch coupled to the capacitor in a parallel connection, wherein the charge and discharge switch will be turned off to make the capacitor to be charged by the mirror current during the on-time of the switching signal and the charge and discharge switch will be turned on to reset the voltage of the capacitor before the on-time of the switching signal starts; and
a minimum on-time comparator coupled to the capacitor and configured to operably compare the feedback voltage with a voltage of the capacitor to generate the pulse signal.

11. The control circuit of claim 1, wherein the detection circuit acquires information of the output voltage from the second voltage during the off-time of the switching signal and adjusts the minimum according to the information of the output voltage.

12. The control circuit of claim 11, wherein the minimum increases when the output voltage increases.

13. The control circuit of claim 1, wherein the detection circuit comprises:
a feedback voltage sample-and-hold circuit configured to operably sample-and-hold the second voltage to generate a feedback voltage related to the output voltage after the power switch is turned off over a preset time;
a minimum on-time generator coupled to the feedback voltage sample-and-hold circuit and configured to operably provide a pulse signal and determine a pulse width of the pulse signal according to the feedback voltage, wherein the pulse width of the pulse signal decides the minimum;
an error amplifier and feedback compensating circuit coupled to the feedback voltage sample-and-hold circuit and configured to operably amplify a difference between the feedback voltage and a reference voltage to generate a current threshold;
a current peak comparator coupled to the error amplifier and feedback compensating circuit and configured to operably comparing the current threshold with a sensing signal related to a current that flows through the primary-side winding to generate a comparison signal for ending the on-time of the switching signal when the sensing signal is higher than the current threshold; and
a signal mask logic circuit coupled to the minimum on-time generator and the current peak comparator and configured to operably mask the comparison signal according to the pulse signal to make the on-time of the switching signal to be not lower than the minimum.

14. The control circuit of claim 13, wherein the minimum on-time generator comprises:
a constant current source configured to operably provide a constant current;
a threshold generator configured to operably generate a minimum on-time threshold according to the feedback voltage; and
a pulse generator coupled to the constant current source and the threshold generator and configured to operably generate the pulse signal according to the constant current and the minimum on-time threshold.

15. The control circuit of claim 14, wherein the threshold generator comprises:
an attenuator or an amplifier configured to operably attenuate or amplify the feedback voltage by a preset proportion to generate a third voltage; and
an adder coupled to the attenuator or the amplifier and configured to operably add up the third voltage and a second reference voltage to generate the minimum on-time threshold.

16. The control circuit of claim 14, wherein the pulse generator comprises:
a capacitor coupled to the constant current source;
a charge and discharge switch coupled to the capacitor in a parallel connection, wherein the charge and discharge switch will be turned off to make the capacitor to be charged by the constant current during the on-time of the switching signal and the charge and discharge switch will be turned on to reset a voltage of the capacitor before the on-time of the switching signal starts; and
a minimum on-time comparator coupled to the capacitor and the threshold generator and configured to operably compare the minimum on-time threshold with the voltage of the capacitor to generate the pulse signal.

17. The control circuit of claim 13, wherein the minimum on-time generator comprises:
a constant current source and configured to operably providing a constant current; and
a pulse generator coupled to the current source and configured to operably generate the pulse signal according to the constant current and the feedback voltage.

18. The control circuit of claim 17, wherein the pulse generator comprises:
a capacitor coupled to the constant current source;
a charge and discharge switch coupled to the capacitor in a parallel connection, wherein the charge and discharge switch will be turned off to make the capacitor to be charged by the constant current during the on-time of the switching signal and the charge and discharge switch will be turned on to reset the voltage of the capacitor before the on-time of the switching signal starts; and
a minimum on-time comparator coupled to the capacitor and configured to operably compare the feedback voltage with the voltage of the capacitor to generate the pulse signal.

19. The control circuit of claim 1, wherein the detection circuit acquires information of the input voltage from the second voltage during the on-time of the switching signal and adjusts the minimum according to the information of the input voltage.

20. The control circuit of claim 19, wherein the minimum decreases as the input voltage increases.

21. The control circuit of claim 1, the detection circuit comprises:
a minimum on-time generator configured to operably provide a pulse signal and generate a clamping current related to the input voltage to hold the second voltage at a zero voltage or a preset voltage, wherein a pulse width of the pulse signal is determined according to the clamping current and the pulse width of the pulse signal decides the minimum;
a feedback voltage sample-and-hold circuit configured to operably sample-and-hold the second voltage to generate a feedback voltage related to the output voltage after the power switch is turned off over a preset time;
an error amplifier and feedback compensating circuit coupled to the feedback voltage sample-and-hold circuit and configured to operably amplify a difference between the feedback voltage and a reference voltage to generate a current threshold;
a current peak comparator coupled to the error amplifier and feedback compensating circuit, configured to operably compare the current threshold with a sensing signal related to a current that flows through the primary-side winding and configured to operably generate a comparison signal for ending the on-time of the switching signal when the sensing signal is higher than the current threshold; and
a signal mask logic circuit coupled to the minimum on-time generator and the current peak comparator and configured to operably masking the comparison signal according to the pulse signal to make the on-time of the switching signal to be not lower than the minimum.

22. The control circuit of claim 21, wherein the minimum on-time generator comprises:
a minimum voltage clamping circuit configured to operably generate the clamping circuit to hold the second voltage at a zero voltage or a preset voltage when the power switch is turned on;
a current mirror coupled to the minimum voltage clamping circuit configured to operably mirror the clamping circuit to generate a mirror current;
a constant voltage source configured to operably provide a fixed threshold; and
a pulse generator coupled to the current mirror and the constant voltage source and configured to operably generate the pulse signal according to the mirror current and the fixed threshold.

23. The control circuit of claim 22, wherein the pulse generator comprises:
a capacitor coupled to the current mirror;
a charge and discharge switch coupled to the capacitor in a parallel connection, wherein the charge and discharge switch will be turned off to make the capacitor to be charged by the mirror current during the on-time of the switching signal and the charge and discharge switch will be turned on to reset a voltage of the capacitor before the on-time of the switching signal starts; and
a minimum on-time comparator coupled to the capacitor and the constant voltage source and configured to operably compare the fixed threshold with the voltage of the capacitor to generate the pulse signal.

24. The control circuit of claim 1, wherein the detection circuit comprises:
an oscillator configured to operably provide a clock;
a flip-flop having a setting terminal which is configured to operably receive the clock, a resetting terminal which is configured to operably receive an output of the detection circuit, and an output terminal; and
a driver coupled to the output terminal of the flip-flop and configured to operably generate the switching signal according to a signal of the output terminal of the flip-flop.

25. A control method for a flyback power converter which includes a transformer and a power switch, wherein the transformer has a primary-side winding coupled to the power switch, a secondary-side winding, and an auxiliary winding configured to operably generate a first voltage in response to switching of the power switch, the control method comprising steps of:
A) generating a switching signal for controlling the switching of the power switch to make the flyback power converter to convert an input voltage into an output voltage, wherein the power switch will be turned on during an on-time of the switching signal and the power switch will be turned off during an off-time of the switching signal; and
B) adjusting a minimum of the on-time of the switching signal according to a second voltage that is in a proportional relationship to the first voltage.

26. The control method of claim 25, further comprising a step of dividing the first voltage to generate the second voltage.

27. The control method of claim 25, wherein the step B comprises steps of:
acquiring information of the input voltage from the second voltage during the on-time of the switching signal;
acquiring information of the output voltage from the second voltage during the off-time of the switching signal; and
adjusting the minimum according to the information of the input voltage and the information of the output voltage.

28. The control method of claim 27, wherein the minimum increases as the output voltage increases, and decreases as the input voltage increases.

29. The control method of claim 25, wherein the step B comprises steps of:
B1) sampling-and-holding the second voltage to generate a feedback voltage related to the output voltage after the power switch is turned off over a preset time;
B2) generating a clamping current related to the input voltage to hold the second voltage at a zero voltage or a preset voltage when the power switch is turned on;
B3) providing a pulse signal, wherein a pulse width of the pulse signal is determined by the feedback voltage and the clamping current and the pulse width of the pulse signal determines the minimum;
B4) amplifying a difference between the feedback voltage and a reference voltage to generate a current threshold;
B5) comparing the current threshold with a sensing signal related to a current that flows through the primary-side winding to generate a comparison signal for ending the on-time of the switching signal when the sensing signal is higher than the current threshold; and
B6) masking the comparison signal by the pulse signal to make the on-time of the switching signal to be not lower than the minimum.

30. The control method of claim 29, wherein the step B3 comprises steps of:
mirroring the clamping current to generate a mirror current;
controlling the mirror current to charge a capacitor during the on-time of the switching signal;
controlling the capacitor to be discharged to reset a voltage of the capacitor before the on-time of the switching signal starts;
generating a minimum on-time threshold according to the feedback voltage; and
comparing the minimum on-time threshold with the voltage of the capacitor to generate the pulse signal.

31. The control method of claim 30, wherein the step of generating a minimum on-time threshold according to the feedback voltage comprises steps of:
attenuating or amplifying the feedback voltage by a preset proportion to generate a third voltage; and
adding up the third voltage and a second reference voltage to generate the minimum on-time threshold.

32. The control method of claim 31, further comprising a step of setting the preset proportion as one.

33. The control method of claim 31, further comprising a step of setting the second reference voltage as zero.

34. The control method of claim 25, wherein the step B comprises steps of:
acquiring information of the output voltage from the second voltage during the off-time of the switching signal; and
adjusting the minimum according to the information of the output voltage.

35. The control method of claim 34, wherein the minimum increases as the output voltage increases.

36. The control method of claim 25, wherein the step B comprises steps of:
B1) sampling-and-holding the second voltage to generate a feedback voltage related to the output voltage after the power switch is turned off over a preset time;
B2) providing a pulse signal and determining a pulse width of the pulse signal according to the feedback voltage, wherein the pulse width of the pulse signal determines the minimum;
B3) amplifying a difference between the feedback voltage and a reference voltage to generate a current threshold;
B4) comparing the current threshold with a sensing signal related to a current that flows through the primary-side winding to generate a comparison signal to end the on-time of the switching signal when the sensing signal is higher than the current threshold; and
B5) masking the comparison signal by the pulse signal to make the on-time of the switching signal to be not lower than the minimum.

37. The control method of claim 36, wherein the step B2 comprises steps of:
providing a constant current;
generating a minimum on-time threshold according to the feedback voltage;
controlling the constant current to charge a capacitor during the on-time of the switching signal;
controlling the capacitor to be discharged to reset the voltage of the capacitor before the on-time of the switching signal starts; and
comparing the minimum on-time threshold with the voltage of the capacitor to generate the pulse signal.

38. The control method of claim 37, wherein the step of generating a minimum on-time threshold according to the feedback voltage comprises steps of:
attenuating or amplifying the feedback voltage by a preset proportion to generate a third voltage; and
adding up the third voltage and a second reference voltage to generate the minimum on-time threshold.

39. The control method of claim 38, further comprising a step of setting the preset proportion as one.

40. The control method of claim 38, further comprising a step of setting the second reference voltage as zero.

41. The control method of claim 25, wherein the step B comprises steps of:
acquiring information of the input voltage from the second voltage during the on-time of the switching signal; and
adjusting the minimum according to the information of the input voltage.

42. The control method of claim 41, wherein the minimum decreases as the input voltage increases.

43. The control method of claim 25, wherein the step B comprises steps of:
B1) generating a clamping current related to the input voltage to hold the second voltage at a zero voltage or a preset voltage when the power switch is turned on;
B2) providing a pulse signal and determining a pulse width of the pulse signal by the clamping current, wherein the pulse width of the pulse signal determines the minimum;
B3) sampling-and-holding the second voltage to generate a feedback voltage related to the output voltage after the power switch is turned off over a preset time;
B4) amplifying a difference between the feedback voltage and a reference voltage to generate a current threshold;
B5) comparing the current threshold with a sensing signal related to a current that flows through the primary-side winding to generating a comparison signal to end the on-time of the switching signal when the sensing signal is higher than the current threshold; and
B6) masking the comparison signal by the pulse signal to make the on-time of the switching signal to be not lower than the minimum.

44. The control method of claim 43, wherein the step B2 comprises steps of:
mirroring the clamping current to generate a mirror current;
controlling the mirror current to charge a capacitor during the on-time of the switching signal;
controlling the capacitor to be discharged to reset a voltage of the capacitor before the on-time of the switching signal starts;
providing a fixed threshold; and
comparing the fixed threshold with the voltage of the capacitor to generate the pulse signal.
